(19) United States
(12) Patent Application Publication
(10) Pub. No.: US 2012/0077507 A1
(43) Pub. Date: Mar. 29, 2012

(54) PREAMBLE SET SEPARATION FOR RANDOM ACCESS CONTROL IN LARGE SCALE CELLULAR NETWORKS

(76) Inventor: Kidong LEE, San Diego, CA (US)

(21) Appl. No.: 13/246,134

(22) Filed: Sep. 27, 2011

Related U.S. Application Data
(60) Provisional application No. 61/387,008, filed on Sep. 28, 2010.

(51) Int. Cl. H04W 72/04

(52) U.S. Cl. 455/450

(57) ABSTRACT

A scheme for random access channel (RACH) configuration for a system that supports Machine-Type Communication (MTC) devices is provided. Upon receiving a random access configuration message from the network, the MTC device sends a random access preamble based on the received random access configuration message. The random access configuration message comprises a field that includes information related to Machine-Type Communication (MTC) preambles, and the random access preamble is selected among a plurality of Machine-Type Communication (MTC) preambles available for use.

### CROSS-REFERENCE

The present disclosure claims priority benefit to the following applications, which contents are all incorporated by reference herein: U.S. Provisional Application No. 61/387,008 (filed Sep. 28, 2010).

### BACKGROUND

In the related art, certain aspects related to random access procedures were problematic, because machine-type communications (MTC) for large-scale cellular networks were not properly considered. As such, the related art technologies do not sufficiently address such issues, and thus do not offer appropriate solutions.

### SUMMARY

The present inventor recognized at least the above-identified drawbacks of the related art. Based upon such recognition, the various features described hereafter have been conceived such that certain procedures related to preamble set separation for random access procedures are more efficiently and effectively performed. In particular, the random access procedures can be improved by employing particular methods for separating preamble sets to support H2H devices and M2M devices as described herein.

### BRIEF DESCRIPTION OF THE DRAWINGS

FIG. 1 shows an exemplary service model for Machine-Type Communication (MTC) employing MTC servers.

FIG. 2 shows an exemplary service model for Machine-Type Communication (MTC) without employing MTC servers.

FIG. 3 shows an exemplary overall network structure supporting MTC services.

FIG. 4 shows an exemplary “RACH-ConfigCommon” Information Element (IE) that is used to specify the generic random access parameters, and employs the concept of using separate preamble sets to support H2H UEs and M2M UEs according to the embodiments described herein.

FIG. 5 shows the descriptions of the various fields in the RACH-ConfigCommon message that employs the concept of using separate preamble sets to support H2H UEs and M2M UEs according to the embodiments described herein.

FIG. 6 shows an exemplary signal flowchart for performing random access procedures by using the RACH-ConfigCommon message that employs the concept of using separate preamble sets to support H2H UEs and M2M UEs according to the embodiments described herein.

FIG. 7 shows the exemplary structures in a UE (or mobile terminal) and in a eNB (or base station) that can support the random access procedures by using the RACH-ConfigCommon message that employs the concept of using separate preamble sets to support H2H UEs and M2M UEs according to the embodiments described herein.

### DETAILED DESCRIPTION

The inventive concepts and features described herein are generally explained in terms of machine type communication (MTC) or machine-to-machine (M2M) communication in 3GPP technology. However, such details are not meant to limit the various features described herein, which are applicable to other types of mobile and/or wireless (radio) communication systems and methods that comply with various types of standards.

The present inventor recognized that conventional random access procedures could be improved. It is important to note that such problem recognition was based upon concentrated investigation, rigorous simulations, and experimental testing conducted by the present inventor. As a result, the present inventor has provided a method of employing the concept of using separate preamble sets. In particular, defining and employing preamble sets to support H2H UEs and M2M UEs has never been provided or suggested in any known technique prior to the work done by the present inventor as described in this disclosure and in the priority document disclosures.

The term “Machine-to-Machine” (M2M), which is also referred to as machine-type communications (MTC), is used to describe various types of technologies that allow wireless and wired (or hybrid) systems to communicate with other devices that have the same (or similar) capabilities. M2M uses a device (e.g., sensor, meter, etc.) to capture or detect some sort of event (e.g., temperature, inventory level, etc.), which is transferred through a network to an application (software program) that translates the captured event into meaningful information. For example, the result of an M2M (MTC) service may inform a store manager that items need to be restocked. Such M2M (MTC) services can be accomplished through the use of telemetry, which is the language that machines use when in communication with each other.

Recently, SMS (Short Messaging Services) can be used as the transmission medium for M2M communication. Developments in direct signaling (Signaling System 7: SS7) via SMS gateways have increased the reliability of M2M communications. Technologies for connecting M2M networks with consumer electronics can improve the speed, connectivity and usefulness of M2M devices that are being implemented for various practical situations. Also, so-called “smart cards” or other types of SIM (Subscriber Identity Module) cards and USIM cards that can be implemented into mobile phones, smart phones, tablet computers, and various other wireless communications devices can have M2M applications and support. Other applications can include M2M being implemented together with RFID (Radio Frequency Identification) technology, M2M being applied to the automobile industry to improve driver safety, M2M cooperating with satellite tracking systems and satellite communications for commercial applications and security monitoring, and the like. There are so-called “open M2M initiatives” such as BITXML (protocol), M2MXML (protocol), the COOS Project (an open-source middleware platform), and many others. Additional concepts, such as Universal Gateways, Protocol Converts, Plant Floor Communications, “Smart Grid” applications, and the like are related to the concepts described with respect to the embodiments of this invention.

With the current technical specifications in 3GPP LTE, it is not possible for the eNB (evolved NodeB, base station) to identify what types of UE's (H2H UE or M2M UE) are competing for random access (RA). So it is not technically efficient or feasible to provide different values of backoff interval (BI) for H2H UE and M2M UE, which have different levels of priority in RA phase.

The present invention suggests a preamble separation method, by making eNB transmit two sets of preambles, so that H2H UEs and M2M UEs can recognize what preamble they can use for RA. By using the preamble separation between H2H UE and M2M UE, the eNB can identify what types of UE's are competing and can properly set the BI values for their own congested situations.

The present inventor recognized the importance and need for distinguishing between preambles for H2H and preambles for MTC. Such distinctions are necessary because H2H traffic and MTC traffic should to be processed with different priorities. Also, if such preamble distinctions can be made, the network (namely, the eNB) can easily and more accurately determine the network or traffic congestion level for all devices being accommodated. As a result, various types of signal processing and network load balancing (such as performing appropriate backoff procedures) can be performed in a more optimal manner.

In order to ensure backward compatibility and smoothly implement enhanced or newly developed features for upgraded network equipment and also to support newer user devices that continue to have increased capabilities, it would be a design goal to support newly implemented services to support MTC, while giving minimal impact to legacy systems, such as H2H devices.

In general, MTC devices (or M2M devices) cannot properly recognize the preambles being broadcast from the network. Namely, such preambles are hidden from the MTC devices. Thus, a field (or some sort of indication) that can inform the MTC device about the MTC preamble needs to be employed in the random access configuration message that the MTC device receives from the network (eNB).

Embodiments of the present invention define and provide a separate (different) set of preambles for MTC devices and for non-MTC devices. The MTC preambles (or M2M preambles) may be applicable for so-called “non-dedicated” preambles. The “non-MTC” preambles are used by non-MTC devices, such as Human-to Human (H2H) devices. The network and the user equipment (or other user devices such as mobile stations and terminals) may employ previously agreed-upon protocols in order to determine which preambles (among all available preambles) are to be used for non-contention situation and for H2H devices. The remaining preambles can then be used for MTC devices.

It is expected that there is market potential for machine-type communication (MTC) services using the currently available wireless network segments. In particular it is possible to identify potential applications for mass machine-to-machine (M2M) service. For example, consumer products manufacturers (such as automobile manufacturers) could keep in touch with their products (i.e. automobiles) after they are shipped.

Another example is in the home environment where remote maintenance of heating and air condition, alarm systems and other applications can also be identified. In addition to identified applications, it can be expected that if there was an easy to use M2M service offering other applications for M2M would be forthcoming.

The current structures that have been optimally designed for human-to-human (H2H) communication service may be sub-optimal to introduce M2M communication service and therefore structures designed for M2M need to be investigated.

Features related to an exemplary network architecture for implementing the concepts described herein will be explained hereafter.

Notation and Key Words:

MTC: Machine-Type Communication(s)

MTC Device: A UE (or other mobile device) equipped for Machine Type Communication, which communicates through a PLMN with MTC Server(s) and/or other MTC Device(s). The terms “MTC device” and “M2M device” are interchangeably used.

MTC Feature(s): Network functions to optimize the network for use by M2M applications.

MTC Server: A (network) entity, which communicates with the PLMN itself, and with MTC Devices through the PLMN. The MTC Server also has an interface which can be accessed by the MTC User. The MTC Server performs services for the MTC User.

MTC User: A MTC User uses the service provided by the MTC Server.

MTC Subscriber: A legal entity (or person) having a contractual relationship with the network operator to provide service to one or more MTC Devices.

Functional Interfaces:

MTCu: Provides MTC Devices access to 3GPP network for the transport of user plane and control plane traffic. The MTCu interface could be based on Un, Urn, Ww and LTE-Uu interfaces.

MTCi: A reference point that MTC Server uses to connect the 3GPP network and thus communicates with MTC Device via 3GPP bearer services/IMS. MTCi could be based on Gi, Sgi, and Wi interface.

MTCsms: A reference point MTC Server uses to connect with the 3GPP network and thus communicates with MTC Device via 3GPP SMS.

An end-to-end application, between the MTC device and the MTC server, uses services provided by the 3GPP system. The 3GPP system provides transport and communication services (including 3GPP bearer services, IMS and SMS) optimized for the Machine-Type Communication (MTC).

The concepts described herein are related to at least one of a plurality of technical standards, which include 3GPP TS 22 (and its sub-sections), TR 23 (and its sub-sections), and TS 36 (and its sub-sections), and TR 37 (and its sub-sections). Such technical documents and their contents are all incorporated by reference herein.

In general, Machine-type nodes (i.e. devices such as mobile phones, sensors, etc.) can be referred to as machine-type communication (MTC) devices or machine-to-machine (M2M) devices. With respect to the radio access network (RAN), the issues related to how random access procedures for many devices need to be performed need to be considered. In the so-called Non-Access Stratum (NAS), signals and information are transferred via a base station (BS), called an evolved Node B (eNB). From the viewpoint of the base station (BS), such signaling is transparent. For network management being performed mainly by a network entity called a Mobility Management Entity (MME), reducing the load in the NAS protocol and in the AS protocol are of concern. For network management being performed mainly based on random access control, access (class) barring, back-off control, admission control (performed at eNB) are of interest. Also, so-called “grouping” (during random access) can be performed. Here, in a so-called “master-slave” relationship among nodes in a network, random access can be performed by a master node.

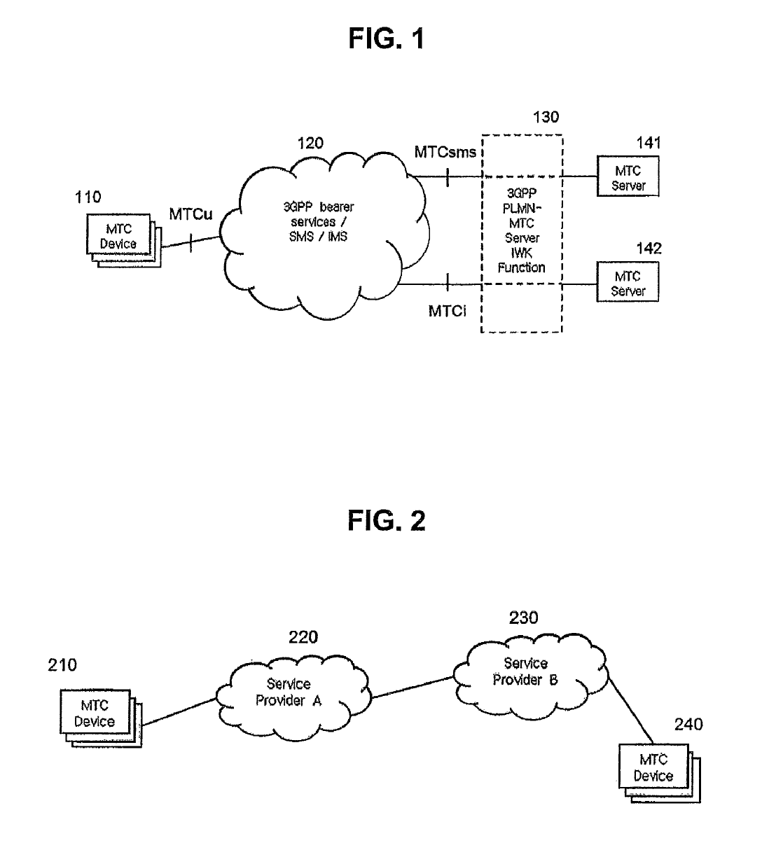

FIG. 1 shows an exemplary service model for Machine-Type Communication with MTC servers. There is shown a conceptual structure in which an MTC Device (110) connects to the 3GPP network (120) (UTRAN, E-UTRAN, GERAN, I-WLAN, etc.) via the MTCu interface. The MTC Device communicates with a MTC Server or other MTC Devices using the 3GPP bearer services, SMS and/or IMS provided by the PLMN (130). The MTC Server (141, 142) is an entity which connects to the 3GPP network via an MTCi interface and/or an MTCsms interface to thus communicate with MTC Devices. The MTC Server may be an entity outside of the operator domain or inside the operator domain.

FIG. 2 shows an exemplary service model for Machine-Type Communication without MTC servers. Certain MTC devices (210) may be in direct communication with a Service Provider A (220), while other MTC devices (240) may be in direct communication with a Service Provider B (230).

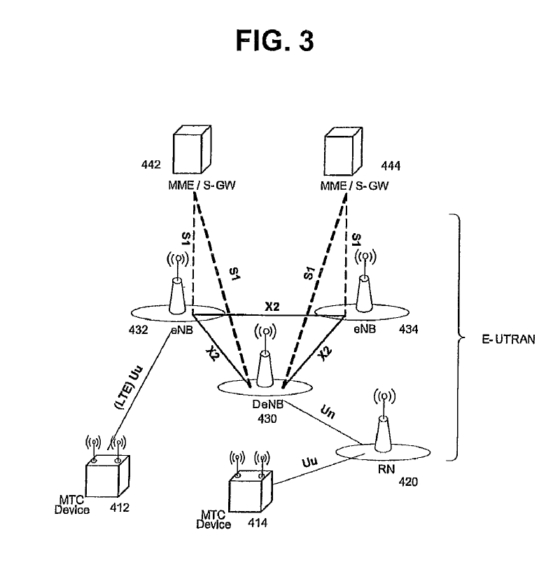

FIG. 3 shows an exemplary network architecture that is applicable for implementing such solution that supports MTC services. The E-UTRAN consists of eNBs (430, 432, 434), which provide the E-UTRA user plane and control plane protocol terminations towards the UE or MTC Device (412, 414). The eNBs are interconnected with each other by means of the so-called X2 interface. The eNBs are also connected by means of the so-called S1 interface to the EPC (Evolved Packet Core), more specifically to the MME (Mobility Management Entity: 442, 444) by means of the S1-MME and to the Serving Gateway (S-GW: 442, 444) by means of the S1-U. The S1 interface supports a many-to-many relationship between MMEs/Serving Gateways and eNBs. The Un interface supports the connection between a so-called Donor eNB (DeNB) and a Relay Node (RN: 420), whereas the Uu interface supports the connection between the RN and UE (MTC Device).

In certain technical specifications at the time of this invention, there is no differentiation among the preambles for H2H UEs and the preambles for M2M UEs. Therefore, a H2H UE and an M2M UE can pick up the same preamble and also can try to use the same RA-RNTI, causing their preamble transmissions to collide. In this case, there is no way for eNB to distinguish the type of UE, whether it is a H2H UE or an M2M UE. Namely, the eNB does not know, whether H2H UEs are competing, whether M2M UEs are competing, or whether any combination of H2H UEs and M2M UEs are competing for traffic resources (i.e., in order to get into RRC CONNECTED mode).

As one way of resolving such problems, the eNB can transmit additional information to UEs (regardless of the UE being a H2H UE or an M2M UE) such that any UE can use the appropriate preamble from one of two separate (or disjoint) sets of preambles, one set for H2H UEs and the other set for M2M UEs.

The first set of preambles can be notified in the same way using the “numberOfRA-Preambles” message, which will be used for H2H UEs to recognize what preambles they can use. The second set of preambles can be notified by use of a newly defined and newly introduced additional field, which may be called a “numberOfRA-MTCPreambles”, and used for M2M UEs to recognize what preambles they can use.

It should be noted that in an exemplary embodiment, the sum of “numberOfRA-Preambles” value and “numberOfRA-MTCPreambles” value must not exceed 64, which shall be handled by eNB. If the eNB will use a portion of preamble for non-contention-based RA, then the summed number must not exceed 64, which is the number of preambles used for non-contention-based RA. Here, it can be easily understood that the particular maximum value for the number of RA MTC preambles is not limited to 64, but can be defined and set to different values according to the specific random access procedures to be employed.

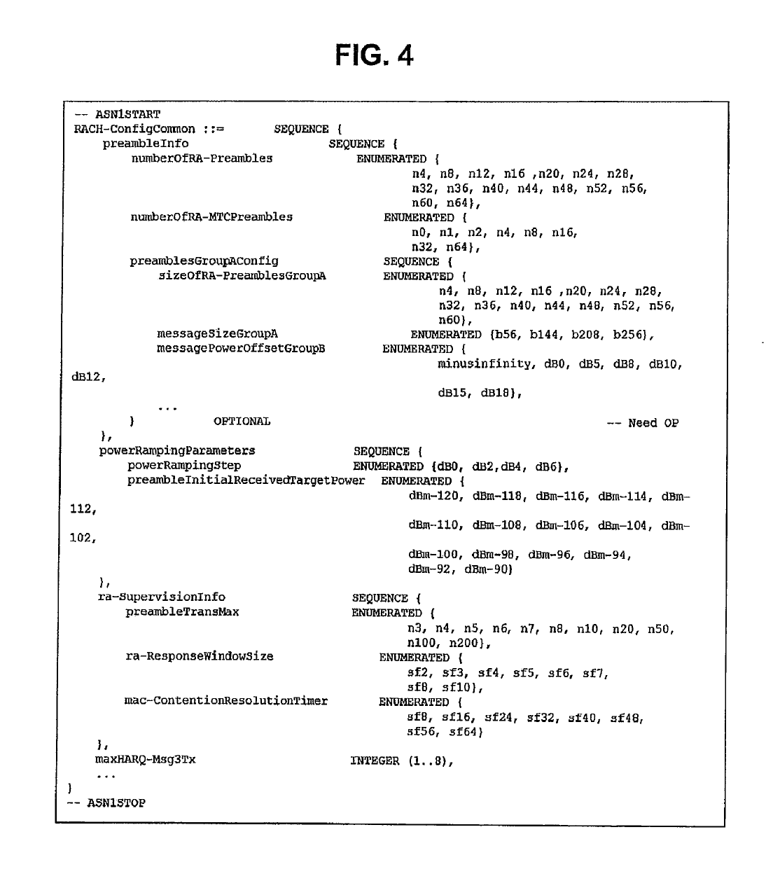

FIG. 4 shows an exemplary “RACH-ConfigCommon” Information Element (IE) that may be used to specify the generic random access parameters, and to specify the separate preamble sets that are used for supporting H2H UEs and M2M UEs according to the embodiments described herein.

Here, the RACH configuration common message (RACH-ConfigCommon) used in embodiments of the present invention is shown to contain three particular parameters in the preamble information (preambleInfo): the number of random access preambles (i.e. “numberOfRA-Preambles”); the number of random access preambles for MTC (i.e. “numberOfRA-MTCPreambles”); and the configuration of the preambles group (i.e. “preamblesGroupAConfig”).

It can be clearly understood that the parameter “numberOfRA-MTCPreambles” has been newly defined and added according to the concepts of this invention. Also, some specific values (i.e., nO, nl, etc.) have been indicated in the enumerated (i.e. ENUMERATED) section, but additional and/or alternative values may be used. The configuration of the preambles group (i.e. “preamblesGroupAConfig”) can contain three parameters: the size of random access preambles for Group A (sizeOfRA-PreamblesGroupA); the message size for Group A (messageSizeGroupA); and the message power offset for Group B (messagePowerOffsetGroupB). Each of these three parameters can further include appropriate values, as shown to be enumerated in FIG. 4.

Additionally, the RACH configuration common message (RACH-ConfigCommon) contains information about power ramping (powerRampingParameters); information about random access supervision (ra-SupervisionInfo); and information about the maximum number of message 3 HARQ transmissions (maxHARQ-Msg3Tx). Such information can further include appropriate values, as shown to be enumerated in FIG. 4.

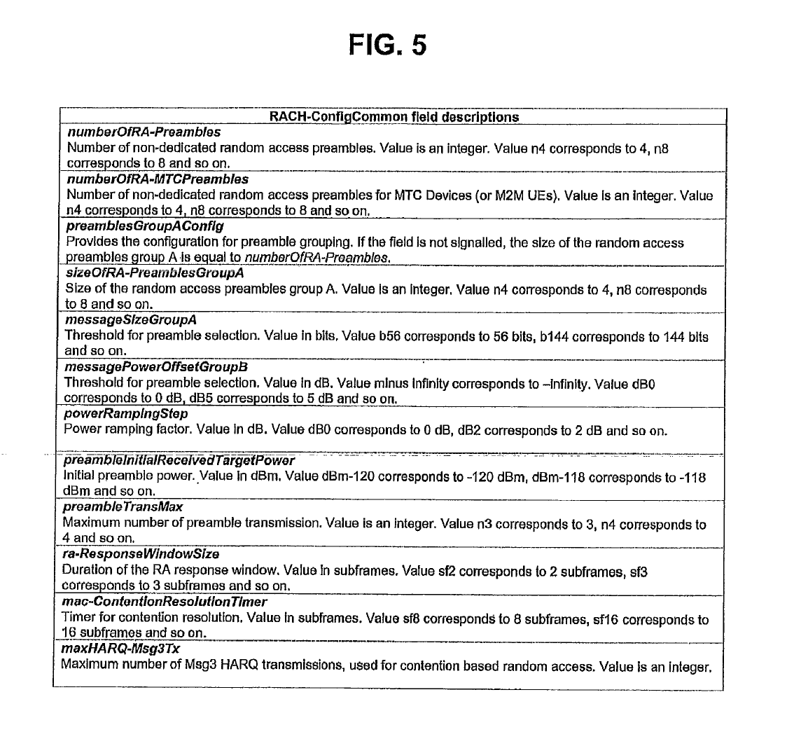

FIG. 5 shows the descriptions of the various exemplary fields in the RACH-ConfigCommon that employs the concept of using separate preamble sets to support H2H UEs and M2M UEs according to the embodiments described herein.

Here, the details and description of each field can be specified as follows:

numberOfRA-Preambles: Number of non-dedicated random access preambles. Value is an integer. Value n4 corresponds to 4, n8 corresponds to 8 and so on.

numberOfRA-MTCPreambles: Number of non-dedicated random access preambles for MTC Devices (or M2M UEs). Value is an integer. Value n4 corresponds to 4, n8 corresponds to 8 and so on.

preamblesGroupAConfig: Provides the configuration for preamble grouping. If the field is not signalled, the size of the random access preambles group A is equal to numberOfRA-Preambles.

sizeOfRA-PreamblesGroupA: Size of the random access preambles group A. Value is an integer. Value n4 corresponds to 4, n8 corresponds to 8 and so on.

messageSizeGroupA: Threshold for preamble selection. Value in bits. Value b56 corresponds to 56 bits, b144 corresponds to 144 bits and so on.

messagePowerOffsetGroupB: Threshold for preamble selection. Value in dB. Value minus infinity corresponds to—infinity. Value dB0 corresponds to 0 dB, dB5 corresponds to 5 dB and so on.

powerRampingStep: Power ramping factor. Value in dB. Value dB0 corresponds to 0 dB, dB2 corresponds to 2 dB and so on.

preambleInitialReceivedTargetPower: Initial preamble power. Value in dBm. Value dBm-120 corresponds to −120 dBm, dBm-118 corresponds to −118 dBm and so on.

preambleTransMax: Maximum number of preamble transmission. Value is an integer. Value n3 corresponds to 3, n4 corresponds to 4 and so on.

ra-ResponseWindowSize: Duration of the RA response window. Value in subframes. Value sf2 corresponds to 2 subframes, sf3 corresponds to 3 subframes and so on.

mac-ContentionResolutionTimer: Timer for contention resolution. Value in subframes. Value sf8 corresponds to 8 subframes, sf16 corresponds to 16 subframes and so on.

maxHARQ-Msg3Tx: Maximum number of Msg3 HARQ transmissions, used for contention based random access. Value is an integer.

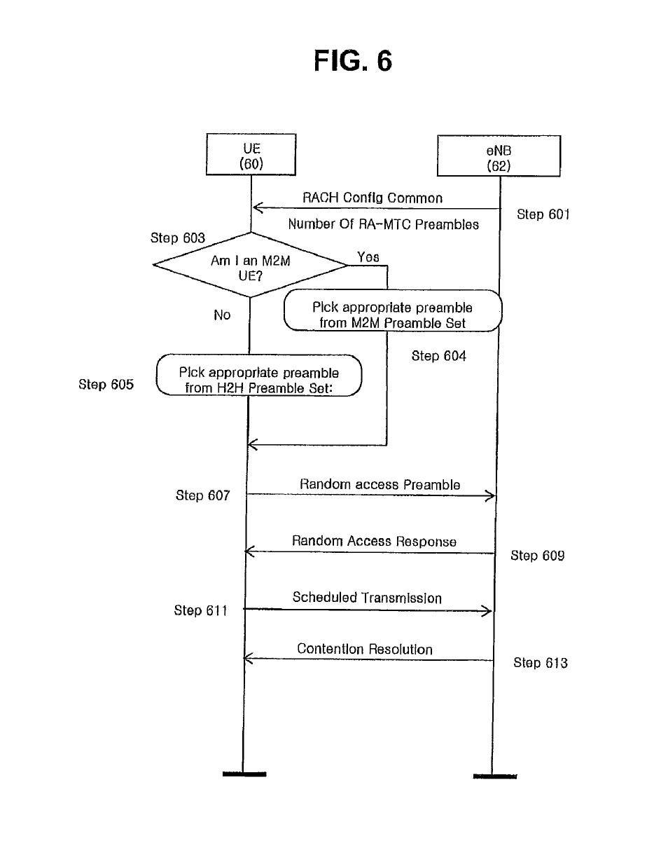

FIG. 6 shows an exemplary signal flowchart for performing random access procedures by using the particular RACH-ConfigCommon message that employs the concept of using separate preamble sets to support H2H UEs and M2M UEs according to the embodiments described herein.

Exemplary signaling between user equipment (UE) 60 (or other user device such as a mobile station) and an evolved Node B 62 (or other network entity such as a base station) are depicted.

In step 601, the eNB 604 first sends a RACH configuration common message (RACH-Config-Common) to the UE 60. Here, the RACH configuration common message includes information about separate preamble sets to support H2H UEs and M2M UEs. Namely, a particular parameter that indicates the number of random access preambles for MTC devices (numberOfRA-MTC Preambles) is generated in the eNB 62 and included into the RACH-Config-Common message.

In step 603, the UE 60, upon receiving the RACH-Config-Common message (that includes the numberOfRA-MTC Preambles), determines whether it is a so-called “M2M” device.

If so, the UE 60 picks or selects an appropriate preamble from the M2M preamble set (Step 604). Otherwise, the UE 60 picks or selects an appropriate preamble from the H2H preamble set (Step 605). Here, it is important to note that the conventional art did not consider whether Machine-Type Communication (MTC) devices (such as an M2M UE) need to obtain and process certain preambles that need to be distinguished from the preambles used for non-MTC devices (namely, so-called H2H devices).

In step 607, after selecting its appropriate preamble, the UE 60 sends such Random Access Preamble message to the eNB 62.

In step 609, the eNB 62 responds by sending a Random Access Response message to the UE 60.

In step 611, the UE c60 begins its scheduled transmission(s) to the eNB 62.

In step 613, the eNB 62 sends a Contention Resolution message to the UE 60 in order to perform appropriate contention resolution.

To sum up, the various inventive concepts and features of the present disclosure can be described in the following manner:

The present disclosure provides a method of random access channel (RACH) configuration for a system that supports Machine-Type Communication (MTC) devices, the method performed by an (MTC) device and comprising: receiving, from a network, a random access configuration message; and sending, to the network, a random access preamble based on the received random access configuration message, wherein the random access configuration message comprises a field that includes information related to Machine-Type Communication (MTC) preambles, and wherein the random access preamble is selected among a plurality of Machine-Type Communication (MTC) preambles available for use.

Here, the random access configuration message is a “RACH-Config-Common” message. The MTC device only uses the MTC preambles. Devices that cannot support Machine-Type Communication cannot use the MTC preambles. Devices that cannot support Machine-Type Communication use the MTC preambles, and wherein said devices that cannot support Machine-Type Communication are human-to-human (H2H) devices. The MTC preambles are non-dedicated preambles. The method further comprises: selecting an MTC preamble among all available preambles excluding preambles used for non-contention-based random access and excluding preambles used as H2H preambles.

The field that includes information related to Machine-Type Communication (MTC) preambles in the random access configuration message allows a set of preambles intended for MTC devices and a different set of preambles intended for non-MTC devices to be distinguished from each other. The information related to MTC preambles included in the field of the random access configuration message is an index.

Also, the present disclosure provides a method of random access channel (RACH) configuration for a system that supports Machine-Type Communication (MTC) devices, the method performed by a network and comprising: generating information related to Machine-Type Communication (MTC) preambles; sending, to a user equipment (UE), a random access configuration message comprising a field that includes the generated information related to Machine-Type Communication (MTC) preambles; and receiving, from the UE, a random access preamble based on the received random access configuration message, the random access preamble having seen selected by the UE among a plurality of Machine-Type Communication (MTC) preambles available for use. Here, the random access configuration message is a “RACH-Config-Common” message. The field that includes information related to Machine-Type Communication (MTC) preambles in the random access configuration message allows a set of preambles intended for MTC devices and a different set of preambles intended for non-MTC devices to be distinguished from each other. The MTC preambles are non-dedicated preambles. The generating step, the sending step, and the receiving step are performed by an evolved Node B (eNB) of the network.

Additionally, the present disclosure provides an apparatus comprising: a radio frequency unit to send and receive signals to and from a network; a memory to store information related to the signals; and a processor, which cooperates with the radio frequency unit and the memory, configured to perform the steps of, receiving, from the network, a random access configuration message, wherein the random access configuration message comprises a field that includes information related to Machine-Type Communication (MTC) preambles; selecting an MTC preamble among all available preambles excluding preambles used for non-contention-based random access and excluding preambles used as H2H preambles; and sending, to the network, a random access preamble based on the received random access configuration message, wherein the field that includes information related to Machine-Type Communication (MTC) preambles in the random access configuration message allows a set of preambles intended for MTC devices and a different set of preambles intended for non-MTC devices to be distinguished from each other.

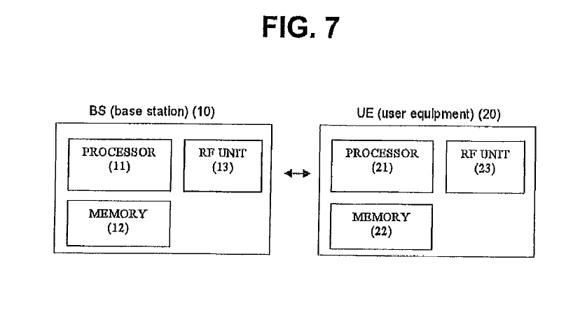

Also, referring to FIG. 7, the present disclosure also provides an apparatus (e.g., device having appropriate hardware components such as a radio frequency (RF) unit (13, 23), a processing unit (controller, CPU, microprocessor(s), etc.) (11, 21) that can access and execute corresponding software code stored in memory or storage, etc. (12, 22) in order to implement and carry out the above-described method.

The various features and concepts described herein may be implemented in software, hardware, or a combination thereof. For example, a computer program (that is executed by a processor, controller, CPU, etc. in a computer, a mobile terminal and/or a network device) that implements a method and apparatus for random access channel (RACH) configuration for a system that supports Machine-Type Communication (MTC) with separate preamble sets for H2H devices and MTC (M2M) devices may be comprised of one or more program code sections or modules for performing various tasks. Similarly, a software tool (that is executed by a processor, controller, CPU, etc. in a computer, a mobile terminal and/or a network device) for a method and apparatus for random access channel (RACH) configuration for a system that supports Machine-Type Communication (MTC) with separate preamble sets for H2H devices and MTC (M2M) devices may comprise program code sections or modules that are executed by a processor (or other controller such as a CPU) for performing various tasks.

The method and apparatus for random access channel (RACH) configuration for a system that supports Machine-Type Communication (MTC) with separate preamble sets for H2H devices and MTC (M2M) devices are compatible with various types of technologies and standards. Certain concepts described herein are related to particular standards, such as 3GPP (GSM, WCDMA, UMTS, LTE, LTE-Advanced, etc.), IEEE 802, 4G, and the like. However, it can be understood that the above exemplary standards are not intended to be limited, as other related standards and technologies would also be applicable to the various features and concepts described herein.

### INDUSTRIAL APPLICABILITY

The features and concepts herein are applicable to and can be implemented in various types of user devices (e.g., mobile terminals, handsets, wireless communication devices, etc.) and/or network devices, entities, components, etc. that can be configured to support random access channel (RACH) configuration for a system that supports Machine-Type Communication (MTC) with separate preamble sets for H2H devices and MTC (M2M) devices.

As the various concepts and features described herein may be embodied in several forms without departing from the characteristics thereof, it should also be understood that the above-described embodiments are not limited by any of the details of the foregoing description, unless otherwise specified, but rather should be construed broadly within its scope as defined in the appended claims. Therefore, all changes and modifications that fall within such scope or equivalents thereof are therefore intended to be embraced by the appended claims.

1. A method of random access channel (RACH) configuration for a system that supports Machine-Type Communication (MTC) devices, the method performed by an (MTC) device and comprising:
receiving, from a network, a random access configuration message; and
sending, to the network, a random access preamble based on the received random access configuration message,
wherein the random access configuration message comprises a field that includes information related to Machine-Type Communication (MTC) preambles, and
wherein the random access preamble is selected among a plurality of Machine-Type Communication (MTC) preambles available for use.

2. The method of claim 1, wherein the random access configuration message is a “RACH-Config-Common” message.

3. The method of claim 1, wherein the MTC device only uses the MTC preambles.

4. The method of claim 1, wherein devices that cannot support Machine-Type Communication cannot use the MTC preambles.

5. The method of claim 1, wherein devices that cannot support Machine-Type Communication use the MTC preambles, and wherein said devices that cannot support Machine-Type Communication are human-to-human (H2H) devices.

6. The method of claim 1, wherein the MTC preambles are non-dedicated preambles.

7. The method of claim 1, further comprising:
selecting an MTC preamble among all available preambles excluding preambles used for non-contention-based random access and excluding preambles used as H2H preambles.

8. The method of claim 1, wherein the field that includes information related to Machine-Type Communication (MTC) preambles in the random access configuration message allows a set of preambles intended for MTC devices and a different set of preambles intended for non-MTC devices to be distinguished from each other.

9. The method of claim 1, wherein the information related to MTC preambles included in the field of the random access configuration message is an index.

10. A method of random access channel (RACH) configuration for a system that supports Machine-Type Communication (MTC) devices, the method performed by a network and comprising:
generating information related to Machine-Type Communication (MTC) preambles;
sending, to a user equipment (UE), a random access configuration message comprising a field that includes the generated information related to Machine-Type Communication (MTC) preambles; and
receiving, from the UE, a random access preamble based on the received random access configuration message, the random access preamble having seen selected by the UE among a plurality of Machine-Type Communication (MTC) preambles available for use.

11. The method of claim 10, wherein the random access configuration message is a “RACH-Config-Common” message.

12. The method of claim 10, wherein the field that includes information related to Machine-Type Communication (MTC) preambles in the random access configuration message allows a set of preambles intended for MTC devices and a different set of preambles intended for non-MTC devices to be distinguished from each other.

13. The method of claim 10, wherein the MTC preambles are non-dedicated preambles.

14. The method of claim 10, wherein the generating step, the sending step, and the receiving step are performed by an evolved Node B (eNB) of the network.

15. An apparatus comprising:
a radio frequency unit to send and receive signals to and from a network;
a memory to store information related to the signals; and
a processor, which cooperates with the radio frequency unit and the memory, configured to perform the steps of,
receiving, from the network, a random access configuration message, wherein the random access configuration message comprises a field that includes information related to Machine-Type Communication (MTC) preambles;
selecting an MTC preamble among all available preambles excluding preambles used for non-contention-based random access and excluding preambles used as H2H preambles; and
sending, to the network, a random access preamble based on the received random access configuration message,
wherein the field that includes information related to Machine-Type Communication (MTC) preambles in the random access configuration message allows a set of preambles intended for MTC devices and a different set of preambles intended for non-MTC devices to be distinguished from each other.
